(19) United States
(12) Patent Application Publication
(10) Pub. No.: US 2023/0318025 A1
(43) Pub. Date: Oct. 5, 2023

(54) ELECTROLYTE FOR LITHIUM SECONDARY BATTERY COMPRISING IONIC LIQUID AND LITHIUM SECONDARY BATTERY COMPRISING THE SAME

(71) Applicants: HYUNDAI MOTOR COMPANY, Seoul (KR); KIA CORPORATION, Seoul (KR)

(72) Inventors: Kyu Ju Kwak, Hwaseong-si (KR); Won Keun Kim, Seoul (KR); Eun Ji Kwon, Yongin-si (KR); Jin Hyeok Cha, Gunpo-si (KR); Yeon Jong Oh, Seoul (KR); Ji Hye Baek, Anyang-si (KR); Dong Hyun Lee, Seoul (KR); Kyoung Han Ryu, Yongin-si (KR); Samuel Seo, Yongin-si (KR)

(73) Assignees: HYUNDAI MOTOR COMPANY, Seoul (KR); KIA CORPORATION, Seoul (KR)

(21) Appl. No.: 18/079,524

(22) Filed: Dec. 12, 2022

(30) Foreign Application Priority Data
Mar. 8, 2022 (KR) 10-2022-0029203

(51) Int. Cl. H01M 10/056; H01M 50/46; H01M 10/052

(52) U.S. Cl. CPC H01M 10/056; H01M 10/052; H01M 50/46

(57) ABSTRACT

The present disclosure relates to an electrolyte for a lithium secondary battery, including an ionic liquid, and a lithium secondary battery having the same. Specifically, the electrolyte may include an ionic liquid containing a cation and an anion, and a lithium salt, and the cation may include a functional group containing an oxygen element.

### CROSS-REFERENCE TO RELATED APPLICATION

This application claims the benefit of priority to Korean Patent Application No. 10-2022-0029203 filed on Mar. 8, 2022 in the Korean Intellectual Property Office, the entire contents of which are incorporated herein by reference.

### TECHNICAL FIELD

The present disclosure relates to an electrolyte for a lithium secondary battery, including an ionic liquid, and a lithium secondary battery having the same.

### BACKGROUND

Chargeable and dischargeable secondary batteries are widely used from small electronic devices such as mobile phones and laptops to large transportation means such as hybrid vehicles and electric vehicles. Accordingly, the demand for high-capacity secondary batteries is increasing. Lithium metal has a high theoretical capacity and a very low oxidation-reduction potential so that it is attracting attention as an anode material for lithium secondary batteries with high capacity and high energy density.

As the capacity of the battery increases, explosion accidents and the like occur frequently so that the importance of the stability of the battery is greatly being highlighted.

Ionic liquid has low volatility and flammability so that it is in the spotlight as a material that can increase the stability of the battery. However, anions constituting the ionic liquid may bind or react with lithium ions, and thus there is a problem in that lithium metal, which is an anode, is dissolved by the ionic liquid.

In order to solve this problem, a technology for preventing further dissolution of lithium metal by using an electrolyte containing an excessive amount of lithium salt has been developed. However, as the concentration of the lithium salt increases, the viscosity of the electrolyte increases so that there is a problem in that a high-density and high-capacity cathode material cannot be used due to the limitation of output characteristics, and lithium ion conductivity is lowered.

### SUMMARY OF THE DISCLOSURE

One aspect of the present disclosure is to provide an electrolyte for a lithium secondary battery, which does not dissolve lithium metal.

Another aspect of the present disclosure is to provide an electrolyte for a lithium secondary battery, which does not form dendritic lithium and produces a coarse and uniform lithium electrodeposition shape.

Still another of the present disclosure is to provide an electrolyte for a lithium secondary battery, which has excellent lithium ion conductivity.

Still another of the present disclosure is to provide an electrolyte for a lithium secondary battery, which is capable of improving battery durability.

The present disclosure is not limited to the aspects mentioned above. The various aspects of the present disclosure will become clearer from the following description, and will be realized by means and combinations thereof described in the claims.

An electrolyte for a lithium secondary battery according to an embodiment of the present disclosure may include: an ionic liquid containing a cation and an anion; and a lithium salt, wherein the cation may include a functional group containing an oxygen element.

The cation may include a precursor in which the functional group is substituted, and the precursor may include at least one of tetraalkylammonium, di-alkylimidazolium, tri-alkylimidazolium, tetra-alkylimidazolium, alkylpyridinium, dialkyl-pyrrolidinium, dialkylpiperidinium, tetraalkylphosphonium, trialkylsulfonium, or any combination thereof.

The functional group may include at least one of an ether group, an ester group, or any combination thereof.

The cation may include N-methoxyethyl-N-methylpyrrolidinium.

The anion may include at least one of BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN-, SeCN-, CuCl₂⁻, AlCl₄⁻, F(HF)_{2.3}⁻, or any combination thereof.

The lithium salt may include at least one of LiFSI, LiTFSI, LiPF₆, LiClO₄, LiBF₄, LiSO₃CF₃, LiBOB, LiFOB, LiDFBP, LiTFOP, LiPO₂F₂, LiCl, LiBr, Lil, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, or any combination thereof.

In the electrolyte, a concentration of the lithium salt may range of about 3 M or more.

In the electrolyte, a concentration of the lithium salt may range from about 4 M to about 5 M.

The cation and a lithium ion of the ionic liquid may have a bonding length of about 1.7 Å or more and less than about 3.4 Å.

According to an exemplary embodiment of the present disclosure, it is possible to obtain an electrolyte for a lithium secondary battery, which does not dissolve lithium metal.

According to an exemplary embodiment of the present disclosure, it is possible to obtain an electrolyte for a lithium secondary battery, which does not form dendritic lithium and produces a coarse and uniform lithium electrodeposition shape.

According to an exemplary embodiment of the present disclosure, it is possible to obtain an electrolyte for a lithium secondary battery, which has excellent lithium ion conductivity.

According to an exemplary embodiment of the present disclosure, it is possible to obtain an electrolyte for a lithium secondary battery, which is capable of improving battery durability.

The effects of the present disclosure are not limited to the above-mentioned effects. It should be understood that the effects of the present disclosure include all effects that can be inferred from the following description.

### BRIEF DESCRIPTION OF THE DRAWINGS

FIG. 1 is a cross-sectional view showing a lithium secondary battery according to an exemplary embodiment of the present disclosure.

FIG. 2 is a result of measuring lithium dissolution currents of coin cells according to an Example, Comparative Example 1, and Comparative Example 2.

FIG. 3A is a result of measuring electrodeposition behaviors of lithium when the coin cell according to the Example is charged five times. FIG. 3B is a result of measurement at a scale different from that of FIG. 3A.

FIG. 4A is a result of measuring electrodeposition behaviors of lithium when the coin cell according to Comparative Example 2 is charged five times. FIG. 4B is a result of measurement at a scale different from that of FIG. 4A.

FIG. 5 is a result of measuring electrodeposition behaviors of lithium when the coin cell according to Comparative Example 3 is charged five times.

FIG. 6 shows bonding lengths between cations and lithium ions of ionic liquids used in Example and Comparative Example 3.

FIG. 7A is a partial charge distribution diagram of the ionic liquid used in Example. FIG. 7B is a partial charge distribution diagram of the ionic liquid used in Comparative Example 3.

FIG. 8A is a Fourier-transform infrared spectroscopy result for confirming the lithium salt bonding strength for each salt concentration. FIG. 8B is a result of comparing fixed information of FSI⁻.

FIG. 9 is linear voltage-current diagrams of coin cells according to the Example and Comparative Example 4.

FIG. 10 is a result of measuring electrodeposition behaviors of lithium when the coin cell according to the Example is charged five times.

FIG. 11 is a result of measuring electrodeposition behaviors of lithium when the coin cell according to Comparative Example 4 is charged five times.

FIG. 12 is a result of measuring capacities of the coin cells according to the Example and Comparative Example 3.

FIG. 13 is a result of measuring lifespans of the coin cells according to the Example, Comparative Example 3, and Comparative Example 4.

### DETAILED DESCRIPTION

The above aspects, other aspects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, the dimensions of the structures are illustrated after being enlarged than the actual dimensions for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part but also the case where there is another part in the middle thereof. Conversely, when a part of a layer, film, region, plate, etc. is said to be “under” other part, this includes not only the case where it is “directly under” the other part, but also the case where there is another part in the middle thereof.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous, and includes all values from a minimum value of such a range to a maximum value including the maximum value, unless otherwise indicated. Furthermore, when such a range refers to an integer, all integers including from a minimum value to a maximum value including the maximum value are included, unless otherwise indicated.

FIG. 1 is a cross-sectional view showing a lithium secondary battery according to an exemplary embodiment of the present disclosure. Referring to this embodiment, the lithium secondary battery may include a cathode 10, an anode 20, and a separator 30 positioned between the cathode 10 and the anode 20. The lithium secondary battery may be one which is impregnated with an electrolyte (not shown).

The cathode 10 may include a cathode active material, a binder, a conductive material, and the like.

The cathode active material may include at least of lithium cobalt oxide, lithium nickel cobalt manganese oxide, lithium nickel cobalt aluminum oxide, lithium iron phosphorus oxide, lithium manganese oxide, or any combination thereof. However, the cathode active material is not limited thereto, and any cathode active material available in the art may be used.

The binder is a component that assists in bonding between the cathode active material and the conductive material or the like and bonding to the current collector, and may include at least one of polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluoro rubber, various copolymers, or any combination thereof.

The conductive material is not particularly limited as long as it has conductivity without causing a chemical change in the battery. For example, it may include: graphite such as natural graphite or artificial graphite; carbon-based materials such as carbon black, acetylene black, Ketjen black, channel black, furnace black, lamp black, and summer black; conductive fibers such as carbon fibers and metal fibers; metal powders such as carbon fluoride, aluminum, and nickel powder; conductive whiskers such as zinc oxide and potassium titanate; conductive metal oxides such as titanium oxide; and conductive materials such as polyphenylene derivatives.

The anode 20 may include lithium metal or a lithium metal alloy.

The lithium metal alloy may include an alloy of lithium and a metal or metalloid capable of alloying with lithium.

The metal or metalloid capable of alloying with lithium may include at least one of Si, Sn, Al, Ge, Pb, Bi, Sb, or any combination thereof.

The lithium metal has a large electric capacity per unit weight, which is advantageous for realization of a high-capacity battery.

The separator 30 may prevent the cathode 10 and anode 20 from contacting each other.

The separator 30 may include any material without limitation as long as it is commonly used in the technical field to which the present disclosure pertains, and may include, for example, one which is formed of a polyolefin-based material such as polypropylene (PP), polyethylene (PE), or the like.

The electrolyte for a lithium secondary battery according to an exemplary embodiment of the present disclosure may include an ionic liquid and a lithium salt.

The conventional electrolyte for a lithium secondary battery is one in which a lithium salt is dissolved in an organic solvent, but the electrolyte according to an exemplary embodiment of the present disclosure may be one which does not include an organic solvent and in which a lithium salt is dissolved in an ionic liquid.

The ionic liquid includes a salt in a liquid state composed of only ions, and may exist in a liquid state at room temperature. The ionic liquid may include a cation and an anion.

The cation may include a functional group containing an oxygen element. The cation may include a precursor in which the functional group is substituted. The precursor may include at least one of tetraalkylammonium, di-alkylimidazolium, trialkylimidazolium, tetra-alkylimidazolium, alkylpyridinium, dialkyl-pyrrolidinium, dialkylpiperidinium, tetraalkylphosphonium, trialkylsulfonium, or any combination thereof. Here, ‘substituted’ may mean that the functional group is contained in the chemical structure of the precursor.

The functional group may include at least one of an ether group, an ester group, or any combination thereof.

Specifically, the cation may include N-methoxyethyl-N-methylpyrrolidinium represented by Chemical Formula 1 below.

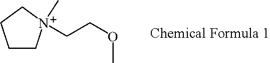

The present disclosure is characterized in that an ionic liquid containing a specific functional group is used as described above so that the lithium ion conductivity of the electrolyte is not dropped even under conditions of high concentration lithium salt and high viscosity. Accordingly, the capacity and durability of the battery can be improved.

The anion may include at least one of BF₄⁻, B(CN)₄⁻, CH₃BF₃⁻, CH₂CHBF₃⁻, CF3BF3⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃) ⁻, N(SO₂F)₂, N(CN)₂-, C(CN)₃⁻, SCN-, SeCN-, CuCl₂⁻, AlCl₄⁻, F(HF)₂.₃⁻, or any combination thereof.

The lithium salt may include at least one of LiFSI, LiTFSI, LiPF₆, LiClO₄, LiBF₄, LiSO₃CF₃, LiBOB, LiFOB, LiDFBP, LiTFOP, LiPO₂F₂, LiCl, LiBr, Lil, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, or any combination thereof.

The lithium salt may have a concentration of about 3 M or more, or may range from about 4 M to about 5 M. When the concentration of the lithium salt is the same as above, the anode 20 comprising lithium metal may be prevented from being dissolved by the ionic liquid.

Hereinafter, the present disclosure will be described in more detail through a specific Example. The following Example is merely illustrative to help the understanding of the present disclosure, and the scope of the present disclosure is not limited thereto.

### EXAMPLE

A unit cell in the form of a coin cell (R2032) was manufactured. Specifically, the coin cell is based on a design of 800 Wh/L, and includes a cathode (2.58 mAh/cm², 14 pi) containing NCM811 as an active material, an anode (20 µm, 16 pi) that is a lithium thin film, and a polyethylene separator (14 µm, 18 pi) of which both surfaces are coated with silica.

As an electrolyte, one in which 4 M LiFSI was dissolved in an ionic liquid was used.

The ionic liquid contains N-methoxyethyl-N-methylpyrrolidinium represented by Chemical Formula 1 below as a cation and N(SO₂F)₂⁻ as an anion.

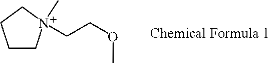

The electrolyte was injected into the coin cell at about 3 g/Ah.

The durability of the coin cell was evaluated under C/3-rate CC-CV (constant voltage) charge and C/3 CC discharge conditions after activating the electrode at C/10-rate CC (constant current)/CC charging/discharging 2-cycle.

The CV charging section started when the C/20 current was reached, and the voltage was adjusted to 4.20 V, 4.25 V, and 4.30 V depending on the evaluation conditions.

All evaluations were performed at room temperature (25° C.).

### Comparative Example 1

As an electrolytic solution, one in which 0.5 M LiFSI was dissolved in an ionic liquid was used. A coin cell was manufactured using the same material and method as in the above Example except for that.

### Comparative Example 2

As an electrolytic solution, one in which 2.0 M LiFSI was dissolved in an ionic liquid was used. A coin cell was manufactured using the same material and method as in the above Example except for that.

### Comparative Example 3

The ionic liquid contains N-butyl-N-methylpyrrolidinium represented by Chemical Formula 2 below as a cation and N(SO₂F)₂⁻ as an anion.

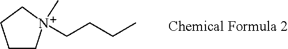

A coin cell was manufactured using the same material and method as in the above Example except for that.

### Comparative Example 4

As an electrolyte, one in which 4 M LiFSI was dissolved in 1,2-dimethoxyethane (DME), an organic solvent, was used. A coin cell was manufactured using the same material and method as in the above Example except for that.

### Experimental Example 1

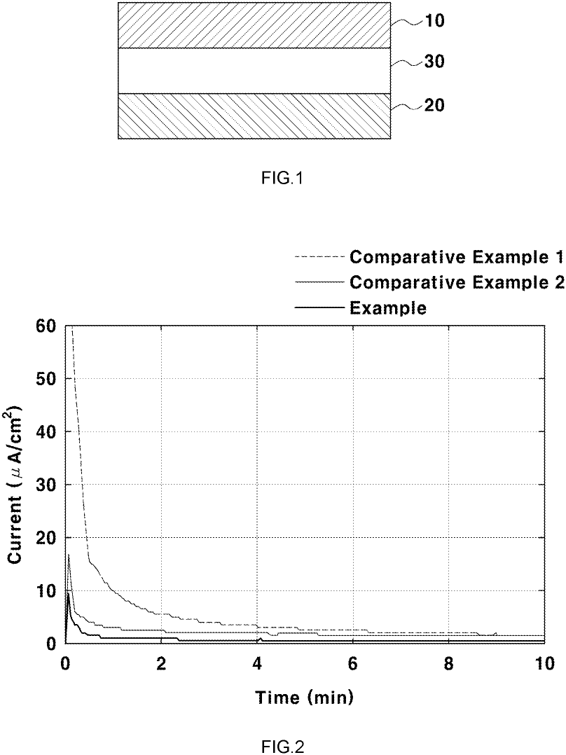

The lithium dissolution currents of the coin cells according to the Example, Comparative Example 1, and Comparative Example 2 were measured. The results are as shown in FIG. 2. Referring to this figure, it can be seen that when the concentration of the lithium salt increases, the dissolution current of lithium decreases. In particular, it can be seen that dissolution of lithium is extremely limited when the concentration of the lithium salt is 4 M as in the Example. As a result, it can be confirmed that when an ionic liquid is used as an electrolyte as in the present disclosure, the concentration of the lithium salt should be 3 M or more, or 4 M or more so that dissolution of the anode can be prevented.

### Experimental Example 2

When driving the coin cells according to the Example, Comparative Example 2, and Comparative Example 3, the electrodeposition behaviors of lithium were analyzed by a scanning electron microscope (SEM).

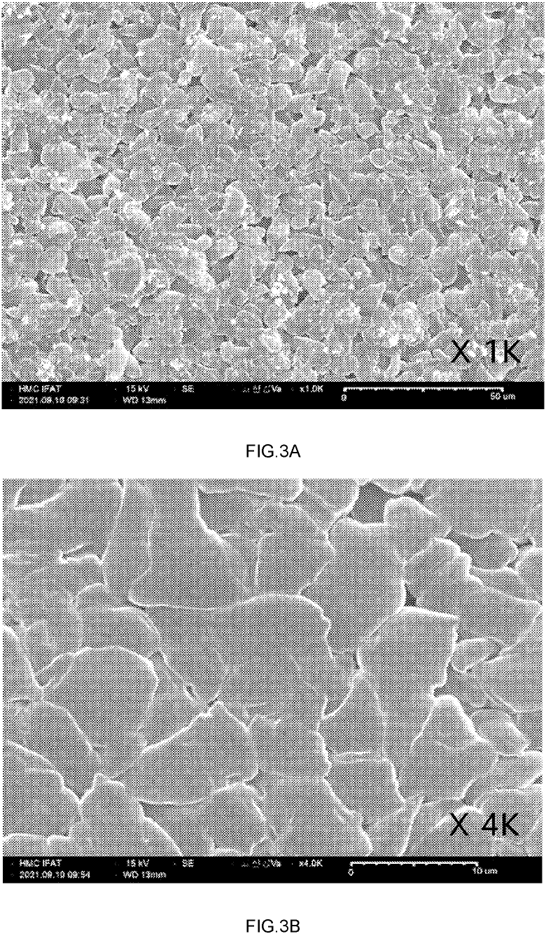

FIG. 3A is a result of measuring electrodeposition behaviors of lithium when the coin cell according to the Example is charged five times. FIG. 3B is a result of measurement at a scale different from that of FIG. 3A.

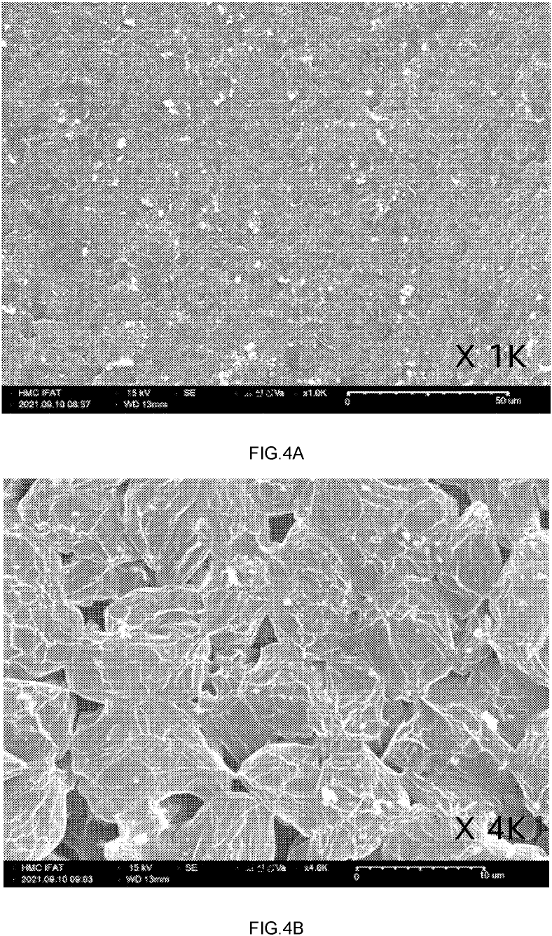

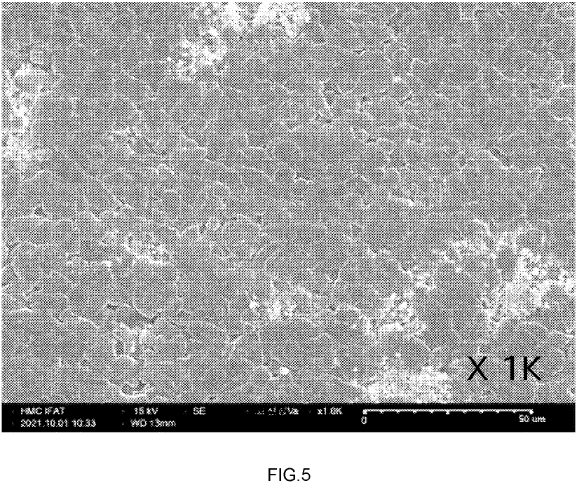

FIG. 4A is a result of measuring electrodeposition behaviors of lithium when the coin cell according to Comparative Example 2 is charged five times. FIG. 4B is a result of measurement at a scale different from that of FIG. 4A.

FIG. 5 is a result of measuring electrodeposition behaviors of lithium when the coin cell according to Comparative Example 3 is charged five times.

Referring to FIGS. 3A and 3B, a uniform and coarsened high-density lithium electrodeposition shape is observed from the coin cell according to an exemplary embodiment of the present disclosure. On the other hand, it can be seen that lithium is irregularly electrodeposited in the coin cells according to Comparative Examples 2 and 3.

### Experimental Example 3

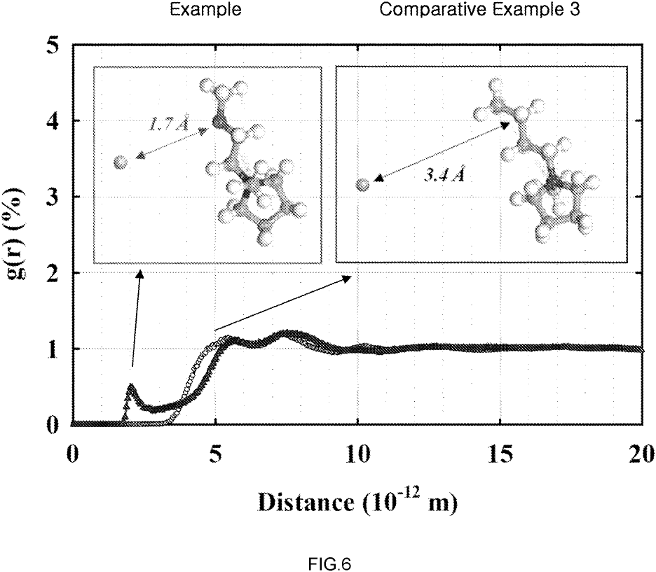

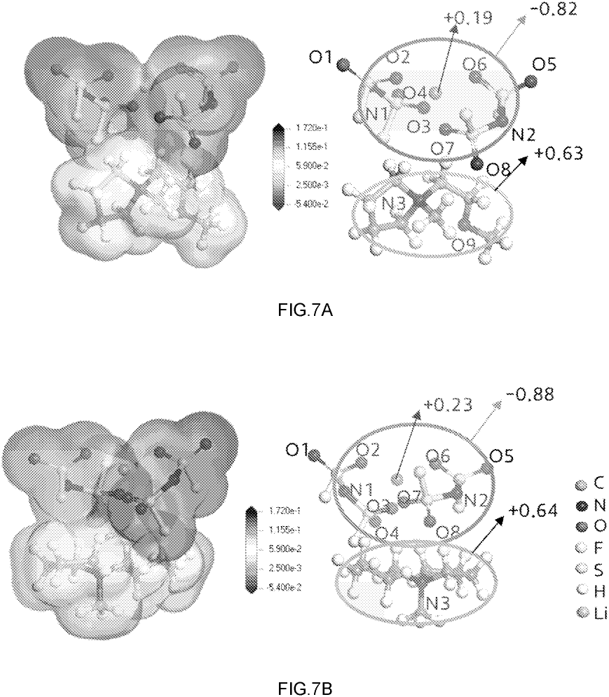

FIG. 6 shows bonding lengths between cations and lithium ions of ionic liquids used in Example and Comparative Example 3. FIG. 7A is a partial charge distribution diagram of the ionic liquid used in the Example. FIG. 7B is a partial charge distribution diagram of the ionic liquid used in Comparative Example 3.

Referring to FIG. 6, it can be seen that the bonding length between the cations and lithium ions of the ionic liquid is decreased in the Example compared to Comparative Example 3. The bonding length of Comparative Example 3 is about 3.4 Å, and the bonding length of Example is about 1.7 Å. That is, in the Example using an ionic liquid containing an ether group, bonding length of the Example is reduced due to the attraction between the cation, precisely, the oxygen element and the lithium ions.

Further, referring to FIG. 7A, the ionic liquid according to the Example has a negative charge of oxygen element, which means that oxygen element is a position where it can interact with the lithium salt.

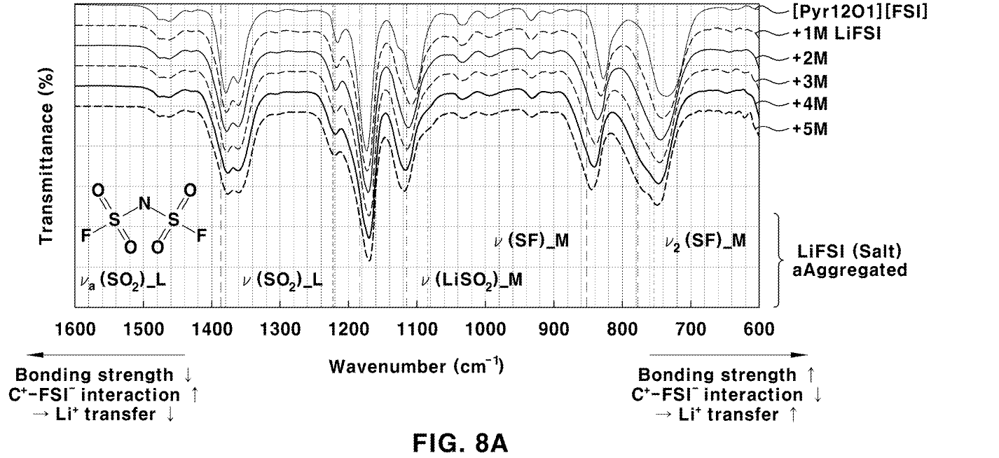

FIG. 8A is a Fourier-transform infrared spectroscopy result for confirming the lithium salt bonding strength for each salt concentration. FIG. 8B is a result of comparing fixed information of FSI⁻. The result of FIG. 8A is used so that the bonding strength of FSI- may be confirmed, and the difference and change in the cation-anion interaction may be interpreted.

Referring to FIGS. 8A and 8B, when the lithium salt concentration increases, the bonding strength between cations such as Li⁺ and Pyr14/Pyr12O1 and the anions of FSI- is strengthened so that the mobility of FSI- in the electrolyte decreases. Therefore, it can be predicted that lithium ion (Li⁺) movement is reduced.

Such behaviors are relaxed in an ionic liquid containing a functionalized functional group. This can be seen in comparison with the measurement results in an ionic liquid that does not contain a functionalized functional group.

In other words, the bonding strength between the Pyr14 cation and the FSI⁻ anion becomes greater than the bonding strength between the Pyr12O1 cation and the FSI⁻ anion at the same concentration, and the access of the lithium ions becomes easier so that the Li-cation bond becomes strong.

Further, [Pyr12O1][FSI], which is an ionic liquid containing a functionalized functional group such as ether, alleviates aggregation with increasing concentration. It is expected that rapid ion transfer capable of overcoming the increase in viscosity caused by the change in lithium salt concentration will be possible.

Particularly, the effect of the functionalized functional group is maximized when the lithium salt is added in an amount of 1 equivalent or more, that is, 3 M or more of the functionalized functional group. Since two FSI⁻ may be bonded to each lithium ion, extra lithium ions that are not bonded to FSI⁻ interact with functional groups more sensitively, and the effect may be highlighted.

As described above, as the lithium ions and the ionic liquid’s oxygen element interact, the partial charge of the ionic liquid decreases, and accordingly, the interaction between the lithium ions and the ionic liquid’s anions is weakened. As a result, the movement of the lithium ions becomes active, which means that a decrease in lithium ion conductivity can be prevented by using an ionic liquid having a functional group containing an oxygen element as in the present disclosure.

### Experimental Example 4

FIG. 9 is linear voltage-current diagrams of coin cells according to the Example and Comparative Example 4. Since the ether-based organic solvent used in Comparative Example 4 contains an ether group, lithium ions can be transferred, but there is a problem in that oxidation stability is low. Referring to FIG. 9, it can be seen that the Example shows much excellent high voltage stability than Comparative Example 4. As a result, it can be confirmed that an electrolyte having high lithium ion conductivity and excellent oxidation stability can be obtained by using an ionic liquid containing an ether group as in the present disclosure.

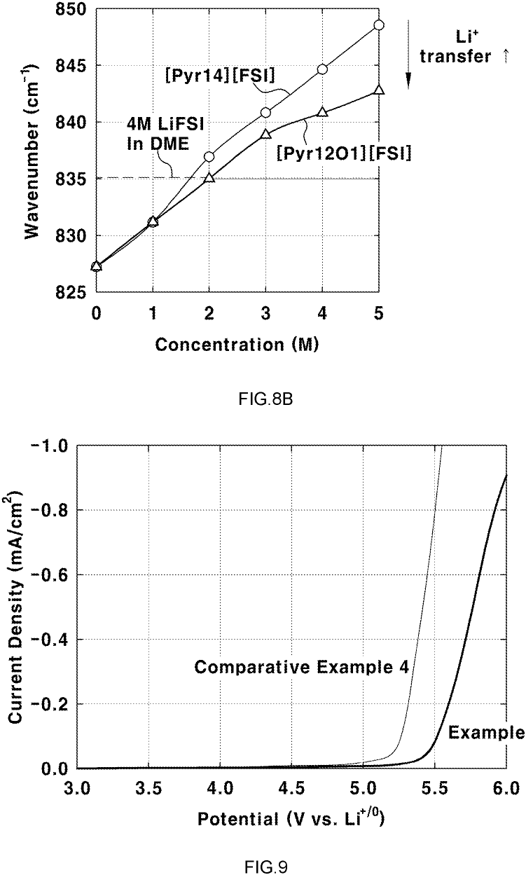

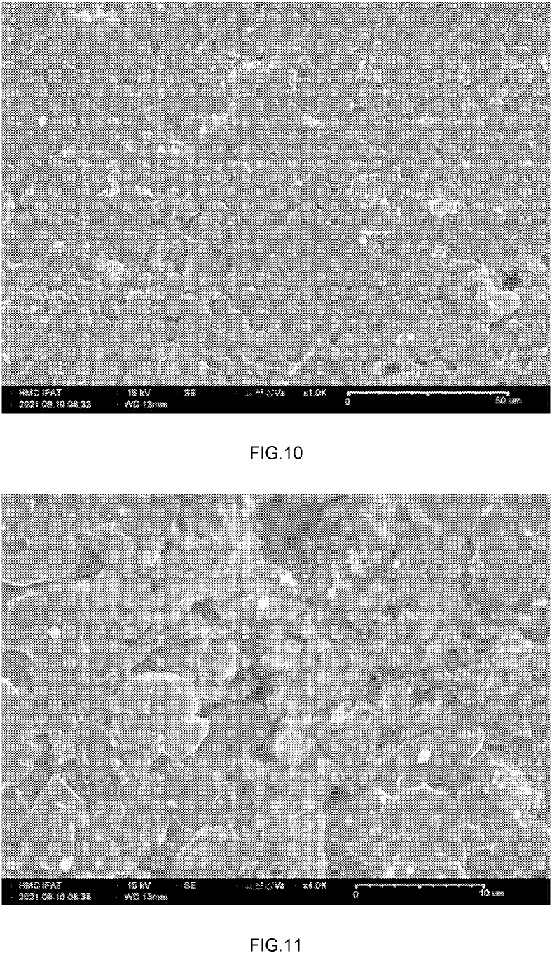

FIG. 10 is a result of measuring electrodeposition behaviors of lithium when the coin cell according to the Example is charged five times. FIG. 11 is a result of measuring electrodeposition behaviors of lithium when the coin cell according to Comparative Example 4 is charged five times. Referring to FIG. 11, it can be seen that the coin cell of Comparative Example 4 has a very rough lithium electrodeposition shape unlike that of the Example.

### Experimental Example 5

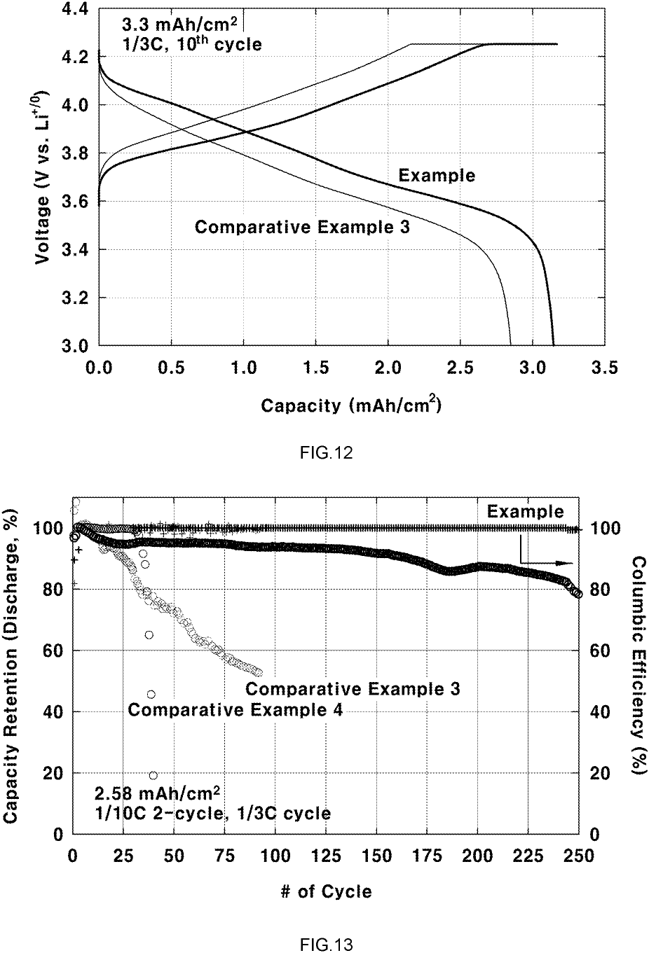

FIG. 12 is a result of measuring capacities of the coin cells according to the Example and Comparative Example 3. FIG. 13 is a result of measuring lifespans of the coin cells according to the Example, Comparative Example 3, and Comparative Example 4.

Referring to FIGS. 12 and 13, it can be seen that the coin cell according to the Example has a high capacity and a long lifespan even though it has a high energy density of 800 Wh/L class.

Hereinabove, embodiments of the present disclosure have been described with reference to the accompanying drawings, but those with ordinary skill in the art to which the present disclosure pertains will understand that the present disclosure may be implemented in other specific forms without changing the technical spirit or essential features thereof. Therefore, it should be understood that the embodiments described above are illustrative in all respects and not restrictive.

What is claimed is:

1. An electrolyte for a lithium secondary battery, the electrolyte comprising:
an ionic liquid containing a cation and an anion; and
a lithium salt,
wherein the cation comprises a functional group containing an oxygen element.

2. The electrolyte of claim 1, wherein the cation comprises a precursor in which the functional group is substituted, and
the precursor comprises at least one of tetraalkylammonium, dialkylimidazolium, tri-alkylimidazolium, tetra-alkylimidazolium, alkylpyridinium, dialkyl-pyrrolidinium, dialkylpiperidinium, tetraalkylphosphonium, trialkylsulfonium, or any combination thereof.

3. The electrolyte of claim 1, wherein the functional group comprises at least one of an ether group, an ester group, or any combination thereof.

4. The electrolyte of claim 1, wherein the cation includes N-methoxyethyl-N-methylpyrrolidinium.

5. The electrolyte of claim 1, wherein the anion comprises at least one of BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃) ⁻, N(SO₂F)₂⁻, N(CN)₂⁻, C(CN)₃⁻, SCN-, SeCN-, CuCl₂₋, AlCl₄⁻, F(HF)_{2.3}⁻, or any combination thereof.

6. The electrolyte of claim 1, wherein the lithium salt comprises at least one of LiFSI, LiTFSI, LiPF₆, LiClO₄, LiBF₄, LiSO₃CF₃, LiBOB, LiFOB, LiDFBP, LiTFOP, LiPO₂F₂, LiCl, LiBr, Lil, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, or any combination thereof.

7. The electrolyte of claim 1, wherein a concentration of the lithium salt ranges of about 3 M or more.

8. The electrolyte of claim 1, wherein a concentration of the lithium salt ranges from about 4 M to about 5 M.

9. The electrolyte of claim 1, wherein the cation and a lithium ion of the ionic liquid have a bonding length of about 1.7 Å or more and less than about 3.4 Å.

10. A lithium secondary battery comprising:
a cathode;
an anode comprising lithium metal; and
a separator interposed between the cathode and the anode,
wherein the lithium secondary battery is impregnated with the electrolyte of claim 1.
